(19) United States
(12) Patent Application Publication
(10) Pub. No.: US 2011/0159274 A1
(43) Pub. Date: Jun. 30, 2011

(54) METHOD OF PRODUCING ANTI-GLARE FILM

(76) Inventors: Kazuhiro Shiojiri, Kanagawa (JP); Kazuhiro Oki, Kanagava (JP); Yuki Saiki, Kanagawa (JP)

(21) Appl. No.: 13/059,784

(22) PCT Filed: Aug. 17, 2009
(86) PCT No.: PCT/JP2009/064684

§ 371 Date: Feb. 18, 2011

(30) Foreign Application Priority Data
Aug. 19, 2008 (JP) 2008-210254

(51) Int. Cl. B32B 5/16; B05D 5/00; B05D 3/00

(52) U.S. Cl. 428/323; 427/162

(57) ABSTRACT

The method for producing an anti-glare film (10) includes a coating solution preparation step in which at least two mutually incompatible resin materials (54) are dissolved in at least one solvent to prepare a coating solution containing particles; a coating step in which the coating solution is coated on a support (16) to form a coating layer (52); a particle migration step in which the particles are made to migrate to the air-liquid interface of the coating layer (52) to be eccentrically located on the surface of the coating layer (52); and a drying step in which the coating layer (52) is dried and phase-separated to form an anti-glare layer (58) and, at the same time, a low refractive index layer (60) comprising the particles on top of the anti-glare layer (58).

### TECHNICAL FIELD

The present invention relates to a method of producing an anti-glare film used for various displays, especially to a method of producing an anti-glare film which can suppress reflection of external light on displays, glare, and a whitening phenomenon due to diffuse reflection.

### BACKGROUND ART

Generally, in various displays such as cathode-ray tube displays, liquid crystal displays, plasma displays, organic EL displays, and the like, there is a problem that, when fluorescent lamps in the room, sunlight from outside, and the like are reflected on the displays, it becomes difficult to watch the display because of the reflected light. In order to solve this problem, an anti-glare film is disposed on the surface of the display for the purpose of scattering the reflected light to improve visibility.

As such an anti-glare film, there have been proposed many types. For example, PTL 1 discloses a method in which a concavo-convex shape is formed on the film surface using particles such as resin beads and, thereby, the light is scattered. Further, in PTL 2 is disclosed a method in which a concavo-convex shape is formed on the film surface by application of spinodal decomposition of a resin without using particles.

Also, there is proposed a method in which a low refractive index layer is formed on the film surface to lower the reflectance. For example, in PTL 3 is disclosed a method to form a layer of inorganic material by a gas-phase step and in PTL 4 is disclosed a method in which an over-coat layer based on a fluorinated material is formed.

In PTL 5 is described a method of forming an anti-glare layer and a low refractive index layer by a single coating, where the anti-glare layer is realized by particles and a fluoroalkylsilane-based compound, which is a polymer having a low refractive index and a property to be eccentrically located easily on the surface, is concurrently coated, thus preventing lowering of productivity due to successive coatings. In PTL 6, the anti-glare property and low reflection property are balanced by controlling the surface concavo-convex structure by application of a self-assembling property of particles with different sizes.

### CITATION LIST

### Patent Literature

PTL 1: Japanese Patent Application Laid-Open No. H6-18706
PTL 2: Japanese Patent Application Laid-Open No. 2004-126495
PTL 3: Japanese Patent Application Laid-Open No. H7-325203
PTL 4: Japanese Patent Application Laid-Open No. 2004-306328
PTL 5: Japanese Patent Application Laid-Open No. 2002-196116
PTL 6: Japanese Patent Application Laid-Open No. 2008-15527

### SUMMARY OF INVENTION

### Technical Problem

However, an anti-glare film such as the one described in PTL 1, which utilizes resin particles, requires use of particles of uniform diameter and was disadvantageous in terms of cost. Further, an anti-glare film such as the one described in PTL 2, which utilizes phase separation, has been difficult to produce stably because the structure inside the film deforms easily depending on the condition of evaporation or the like. Furthermore, these anti-glare films which are provided only with concavo-convex shapes on the surface show strong diffuse reflection on the surface and there has been a problem that the film surface looks whitish.

The methods described in PTL 3 and PTL 4 could solve the above-mentioned problem that the film looks whitish. However, the method of PTL 3 is low in productivity and there has been a problem in terms of cost. Also, the method described in PTL 4 requires coating of a low refractive index layer after providing the anti-glare layer and this successive formation of multiple layers caused low productivity. Further, when multilayered coatings are applied at one time, the respective layers diffuse in and mix with each other and, thus, there has been a problem that the low refractive index layer cannot be formed uniformly on the surface.

Further, with the method described in PTL 5, there has been a problem that its reflection function is not sufficient because the layer of a fluoroalkylsilane-based compound, eccentrically located on the surface has a refractive index not sufficiently different from that of the lower layer. With regard to the film described in PTL 6, it is necessary to use a large amount of inorganic particles, and there has been a problem of high cost.

The present invention was made in view of these circumstances and the object is to provide a method of producing an anti-glare film, which suppresses reflection of external light on various displays, glare, and a whitening phenomenon due to diffuse reflection and which can be produced at a low cost.

### Solution to Problem

In order to attain the above-mentioned object, the first aspect of the present invention provides a method for producing an anti-glare film, comprising a coating solution preparation step in which at least two mutually incompatible resin materials are dissolved in at least one solvent to prepare a coating solution containing particles, a coating step in which the coating solution is coated on a support to form a coating layer, a particle migration step in which the particles are made to migrate to an air-liquid interface of the coating layer to be eccentrically located on the surface of the coating layer, and a drying step in which the coating layer is dried and phase-separated to form an anti-glare layer and to form, at the same time, a low refractive index layer comprising the particles on top of the anti-glare layer.

According to the first aspect, after the coating solution is coated, the particles contained in the coating layer are first made to be eccentrically located on the surface of the coating layer. In this way, the particles can be disposed on the surface of the anti-glare layer formed after drying the coating layer and, thus, a low refractive index layer can be formed. Also, since the low refractive index layer is formed of the particles, a difference in refractive index from the anti-glare layer is easy to obtain, making it possible to prevent the whitening phenomenon of the film.

Also, since a concavo-convex shape is formed on the surface of the anti-glare layer by application of spinodal decomposition involving at least two resin materials, a uniform concavo-convex shape can be formed without using particles and the production cost can be lowered.

Further, by preparing the coating solution by mixing the resin materials and particles, the low refractive index layer and the anti-glare layer can be formed by a single coating and lowering of productivity can be thus prevented.

The second aspect is characterized in that, in the first aspect, the concentration of the resin materials in the coating solution is at least 10% by mass lower than a critical solid content concentration at which phase separation occurs in the coating layer.

According to the second aspect, the solid content concentration of the coating solution prepared in the coating solution preparation step is set at a concentration 10% by mass lower than the critical solid content concentration at which the phase separation occurs. Accordingly, the time from completion of the coating step to occurrence of phase separation during the drying step can be taken longer and, in the particle migration step, it is possible to make the particles migrate sufficiently to the air-liquid interface of the coating layer.

The third aspect is characterized in that, in the first or second aspect, the size of the particles is at least 10 nm and at most 50 nm.

According to the third aspect, the particle size is kept in a range of at least 10 nm and at most 50 nm. Thus, it becomes possible to make a sufficient difference in refractive index from the anti-glare layer and to provide sufficient function to prevent reflection.

The fourth aspect is characterized in that, in any one of the first to third aspects, the particles are surface-modified with a silane coupling agent.

According to the fourth aspect, the particles are surface-modified with a silane coupling agent and are provided with hydrophobicity. Therefore, in the particle migration step, it becomes easier to make the particles migrate to the air-liquid interface and, thus, a sufficient difference in refractive index can be obtained between the low refractive index layer and the anti-glare layer.

The fifth aspect is characterized in that, in any one of the first to fourth aspects, 80% or more of the particles contained in the coating solution is included in the low refractive index layer.

The fifth aspect defines the proportion of particles included in the low refractive index layer and, by keeping the proportion of particles in the range, it becomes possible to obtain a sufficient difference in refractive index between the low refractive index layer and the anti-glare layer. Since the particles not present in the low refractive index layer are present in the anti-glare layer, it becomes difficult to obtain a distinct difference in refractive index between the low refractive index layer and the anti-glare layer, when the amount of particles in the low refractive index layer is small.

The sixth aspect is characterized in that, in any one of the first to fifth aspects, the particles are hollow silica particles.

According to the sixth aspect, by employing hollow silica particles as the particles, it becomes easier for the particles to float and migrate to the air-liquid interface in the particle migration step. Thus, a distinct difference in refractive index can be obtained between the low refractive index layer and anti-glare layer.

The seventh aspect is characterized in that, in any one of the first to sixth aspects, in the drying step, at least one of selection of the solvent, adjustment of drying speed of the solvent and surface-modification of the particles are carried out so that the concentration of the resin material in the coating solution which constitutes the coating layer exceeds the critical solid content concentration, after 40% or more of the particles contained in the coating solution have migrated to within upper 40% of the coating layer in the particle migration step.

The eighth aspect is characterized in that, in the seventh aspect, in the drying step, at least one of selection of the solvent, adjustment of drying speed of the solvent and surface-modification of the particles are carried out so that the concentration of the resin material in the coating solution which constitutes the coating layer exceeds the critical solid content concentration, after 70% or more of the particles contained in the coating solution have migrated to within upper 10% of the coating layer in the particle migration step.

According to the seventh and the eighth aspects, since, in the drying step, at least one of selection of the solvent, adjustment of drying speed of the solvent and surface-modification of the particles are carried out so that the concentration exceeds the critical solid content concentration after 40% or more of the particles have migrated to within upper 40% of the coating layer, it is possible to form a low refractive index layer as the upper layer, even when the particle migration step and the drying step were conducted continuously. In addition, it is more preferable that the concentration exceeds the critical solid content concentration after 70% or more of the particles have migrated to within upper 10% of the coating layer.

In order to attain the above-mentioned object, a ninth aspect of the present invention provides an anti-glare film produced by the method for producing an anti-glare film according to any one of the first to eighth aspects, wherein, 70% or more of the particles are present within 10% of a thickness of a functional layer of the anti-glare film from a surface of the functional layer.

In the anti-glare film produced by the method according to any one of the first to eighth aspects, 70% or more of the particles can be present within 10% of a thickness of a functional layer from a surface of the functional layer of the anti-glare film. Here, the functional layer can be composed of an anti-glare layer and a low refractive index layer. Accordingly, the low refractive index layer can be formed of the particles and it becomes easy to make a difference in refractive index between the low refractive index layer and the anti-glare layer. Further, the whitening phenomenon of the film can be prevented.

### Advantageous Effects of Invention

According to the method of producing an anti-glare film of the present invention, the anti-glare layer and the low refractive index layer are formed by drying after the particles contained in the coating layer were made to be eccentrically located at the air-liquid interface. Accordingly, production is possible without lowering productivity because the anti-glare layer and the low refractive index layer can be formed by a single coating. Also, the whitening phenomenon of the film can be prevented because the low refractive index layer is provided. Further, since a concavo-convex shape is formed on the surface of the anti-glare layer by application of spinodal decomposition involving at least two or more kinds of resin materials, reflection of external light and glare can be prevented and the production cost can be lowered.

### BRIEF DESCRIPTION OF DRAWINGS

FIGS. 1A to 1C are explanatory diagrams illustrating an example of a method of producing an anti-glare film;

FIG. 2 is a schematic view showing an example of an apparatus for producing an anti-glare film; and

FIG. 3 is a table showing examples and comparative examples.

### DESCRIPTION OF EMBODIMENTS

Hereinafter, the preferred embodiment of the method of producing an anti-glare film according to the present invention will be described by referring to the accompanying drawings.

### First Embodiment

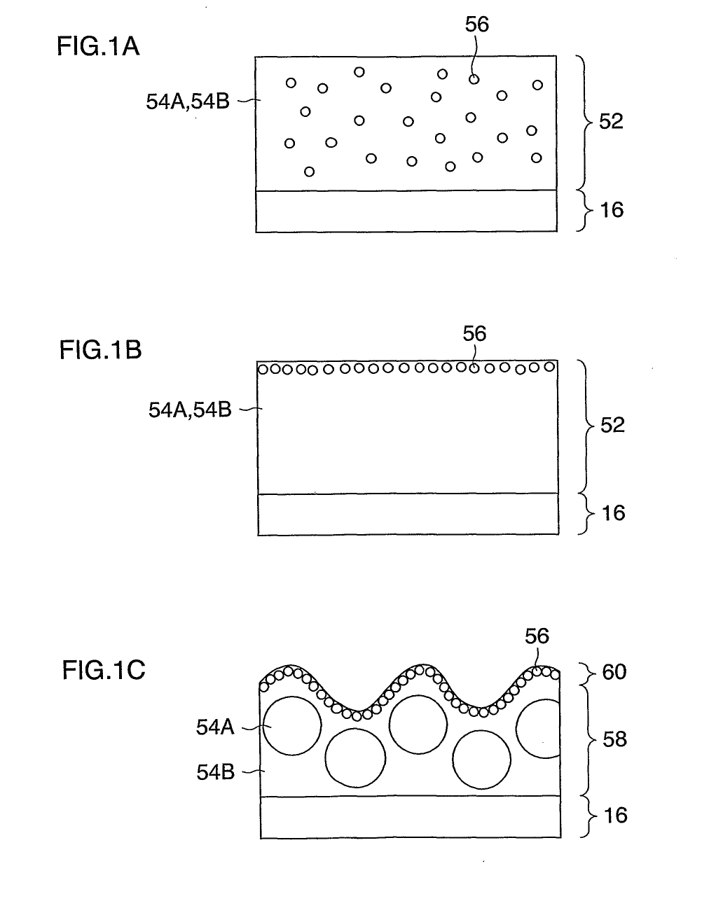

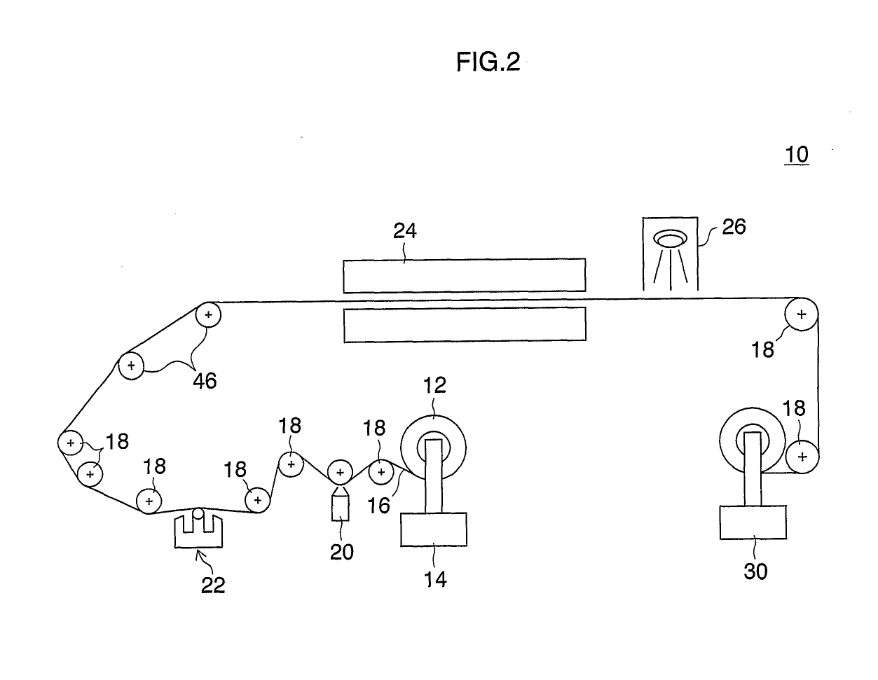

FIGS. 1A to 1C are explanatory diagrams illustrating an example of a method of producing an anti-glare film and FIG. 2 is a schematic view showing an example of an apparatus for producing an anti-glare film. Even though the present embodiment will be described with an example where a coating solution comprising two kinds of resins A and B is used, the fundamental concept is the same when more than two resins are contained.

### (Step for Mixing a Coating Solution)

First, in the method of producing an anti-glare film according to the present invention, two resins A and B, which are mutually incompatible, are dissolved in a solvent and, further, particles are included therein to prepare a coating solution (the coating solution preparation step).

As the particles and resin materials, the materials described later may be used. Also, as a mixing method, any method may be employed without any limitation as long as the resin materials dissolve in the solvent and the particles can be dispersed in the coating solution.

### [Coating Solution]

The coating solution used in the method of producing the anti-glare film of the present invention comprises particles and is prepared by dissolving at least two resin materials, which are mutually incompatible, in at least one solvent.

### <Particles>

As the particles, there may be used any kind of particles without particularly limitation, as long as the refractive index thereof can be lowered than the surrounding resin materials. For example, hollow silica particles and fluorine resin particles may be used and, among these, the hollow silica particles can preferably be used.

Further, the particles are surface-modified and are provided with hydrophobicity. By providing the particles with hydrophobicity, it becomes easier to make the particles migrate to the air-liquid interface of the coating layer after coating the coating solution and to form the low refractive index layer.

The methods of providing hydrophobicity can include (1) surface modification with a coupling agent, (2) a hydrophobizing treatment with a low molecular weight organic compound, (3) a hydrophobizing treatment by surface-coating with a polymer compound, and (4) a method of grafting a hydrophobic polymer. In the following, the specific methods will be described.

(1) Surface Modification with a Coupling Agent

This is a method to treat (coat) the particles with a coupling agent and make the particles hydrophobic by dispersing the particles in a solution of a coupling agent dissolved in an organic solvent and, thereafter, evaporating and removing the organic solvent completely. It is possible to use a wide variety of coupling agents, but preferably mentioned are silane coupling agents containing alkyl chains and silane coupling agents containing fluorine atoms (fluorine-based silane coupling agents).

Specific examples of the silane coupling agents containing alkyl chains include methyltriethoxysilane, trimethyltrichlorosilane, ethyltriethoxysilane, ethyltrichlorosilane, phenyltriethoxysilane, phenyltrichlorosilane, dimethyldiethoxysilane, dimethyldichlorosilane, 3-glycidoxypropyltrimethoxysilane, 3-glycidoxypropylmethyldimethoxysilane, 2-(3,4-epoxycyclohexyl)ethyltrimethoxysilane, 3-aminopropyltriethoxysilane, 3-aminopropyltrimethoxysilane, N-(2-aminoethyl)-3-aminopropylmethyldiethoxysilane, 3-mercaptopropyltrimethoxysilane, vinyltrimethoxysilane, vinyltriethoxysilane, vinyltris(2-methoxyethoxy)silane, and 3-methacryloxypropyltrimethoxysilane.

Specific examples of the fluorine-based silane coupling agents include fluoroalkylsilane coupling agents commercially available from GE Toshiba Silicones Co., Ltd. (the trade name: TSL 8262, TSL 8257, TSL 8233, TSL 8231, and the like) or an alkoxysilane having a perfluoropolyether group. Also, a coupling agent having an element other than silicon may be used as long as it does not affect the refractive index. Specific examples of such coupling agents include titanate coupling agents commercially available from Ajinomoto Co., Inc. (the trade name: Plain Act KR-TTS, KR-46B, KR-55, KR-41B, KR-38S, KR-138S, KR-238S, KR-338X, KR-44, KR-9SA, and KR-ET are exemplified); metal alkoxides such as tetramethoxytitanium, tetraethoxytitanium, tetraisopropoxytitanium, tetra(n-propoxy)titanium, tetra(n-butoxy)titanium, tetra(sec-butoxy)titanium, and tetra(tert-butoxy)titanium.

(2) Hydrophobizing Treatment with a Low Molecular Weight Organic Compound

This is a method to treat (coat) the particles with a low molecular weight organic compound and make the particles hydrophobic by dispersing the particles in a solution of a low molecular weight organic compound in an organic solvent and, thereafter, evaporating and removing the organic solvent completely. As the low molecular weight organic compounds, those with molecular weights (polystyrene equivalent number average molecular weights) of 5000 or less, preferably 3000 or less may be mentioned. Specific examples thereof include low molecular weight organic carboxylic acids such as stearic acid, lauric acid, oleic acid, linoleic acid, and linolenic acid; and low molecular weight organic amines.

(3) Hydrophobizing Treatment by Surface-Coating Treatment with a Polymer Compound

This is a method in which at least a portion of the particle surface is coated with a polymer compound. Specifically, there may be used a method in which a monomer is selectively adsorbed on the particle surface and is subsequently polymerized, an emulsion polymerization method in presence of the particles, a microencapsulation method, a dispersion polymerization method, a suspension polymerization method, a seed polymerization method, a spray drying method, a cooling granulation method, a method to use a supercritical fluid, a hetero aggregation method, a dry microparticle aggregation method, a phase separation method (coacervation method), an interfacial polymerization method, a submerged drying method (interfacial precipitation method), an orifice method, an interfacial inorganic reaction method, an ultrasonication method, and the like. By using any of the above methods, a least a portion of the particle surface can be coated with a desired polymer compound.

The polymer compound has a molecular weight (polystyrene equivalent number average molecular weight) of 5000 or larger, preferably 10000 or larger, and the more hydrophobic the compound is, the more preferably it is used. Specific examples of such polymer compounds include polyolefin resins, polystyrene, resins containing halogens such as a fluorine atom and the like, acrylic resins, nitrogen-containing resins, polyvinyl ether, polyimide resins, polyester resins, polycarbonate resins, silicon resins, PPO resins, phenol resins, xylene resins, amino resins, acetal resins, polyether resins, epoxy resins, penton resins, natural rubber, synthetic rubber alone and/or composite materials thereof (blend or copolymer), polymerized materials of the above-mentioned coupling agents, or organic-inorganic hybrid-type polymer compounds. Specific examples of monomers for the organic-inorganic hybrid-type polymers include organometallic compounds such as alkoxysilanes and are used in combination with the monomers or polymers exemplified in the following paragraph (4). Specific examples of the preferable organic-inorganic hybrid polymers include, as a commercialized product, Compoceran or Uriano (trade names: manufactured by Arakawa Chemical Ind., Ltd.).

### (4) Method of Grafting a Hydrophobic Polymer

This method can be divided into the following three methods.

### (4-1) Method to Make Particles Capture the Propagating Polymer End

The hydrophilic groups present on the particle surface (for example, a hydroxyl group (—OH) present on the surface of silica) has a function to capture active species such as a radical. Thus, by carrying out a polymerization reaction of polyfunctional monomers or oligomers in presence of the particles or by adding inorganic ultrafine particles to the polymerization system of polyfunctional monomers or oligomers, the monomers, oligomers, or polymers having polymerizable functional groups are bound to the surface of the fine particles to carry out hydrophobization of the particles.

(4-2) Method to Initiate a Polymerization Reaction from the Particle Surface

This is a method in which polymerization-initiating active species such as radical polymerization initiators and the like are formed beforehand on the surface of the particles (for example, silica) and polymer is made to propagate from the particle surface using a multifunctional monomer or oligomer. According to this method, high-molecular-weight, polymerizable polymer chains can easily be obtained.

(4-3) Method to Combine a Hydrophilic Group on the Microparticle with a Polymer Having a Reactive Group

This is a method in which a polymer having multifunctional reactive groups are used and includes a method where a hydroxyl group on the particle (for example, a hydroxyl group on the silica surface) and a reactive group at the polymer end are bound directly or a method where the reactive group at the polymer end and/or the hydrophilic group of the microparticle are first combined with other reactive group and, thereafter, the two are bound.

This method allows use of a wide variety of polymers, involves a relatively simple operation, and provides good binding efficiency. In this method, since a dehydration polycondensation reaction between the hydroxyl group on the microparticle surface and the polymer having a reactive group is utilized, it is necessary to disperse the microparticles (for example, silica microparticles) in the polymer and its solution and heat the dispersion at an appropriate temperature for an appropriate time. For example, in the case of silica, it is preferable to heat the mixture generally at 80° C. or higher for 3 hours or longer, although it depends on the amount of polymer.

Among these methods of providing hydrophobicity, the method of providing with a silane coupling agent is preferably employed. By using a silane coupling agent, hydrophobicity can be provided by a simple operation and in an effective manner.

Further, the size of the particles is preferably at least 10 nm and at most 50 nm, more preferably at least 15 nm and at most 40 nm, even more preferably at least 20 nm and at most 30 nm. With the particle size in the range, the low refractive index layer can be made easier to be formed because, in the particle migration step, the particles can be made easier to migrate to the air-liquid interface.

### <Resin Material>

As the resin material, at least two resin materials can be used without any limitation as long as they are mutually incompatible but, generally, thermoplastic resins are used. The thermoplastic resins can include styrene resins, (meth)acrylic resins, resins based on organic acid vinyl ester, vinyl ether resins, halogen-containing resins, olefin resins (including cycloaliphatic olefin resins), polycarbonate resins, polyester resins, polyamide resins, thermoplastic polyurethane resins, polysulfone resins (polyether sulfone, polysulfone, and the like), polyphenylene ether resins (polymer of 2,6-xylenol and the like), cellulose derivatives (cellulose esters, cellulose carbamates, cellulose ethers, and the like), silicone resins (polydimethylsiloxane, polymethylphenylsiloxane, and the like), rubbers or elastomers (diene rubber such as polybutadiene, polyisoprene, and the like; styrene-butadiene copolymer; acrylonitrile-butadiene copolymer; acrylic rubber; urethane rubber; silicone rubber; and the like). These thermoplastic polymers can be used in a combination of two or more kinds.

As the (meth)acrylic resins, there may be used homo- or copolymers of (meth)acrylic monomers, and copolymers of (meth)acrylic monomers and copolymerizable monomers. The (meth)acrylic monomers can include, for example, (meth)acrylic acid; C1-10 alkyl(meth)acrylates such as methyl(meth)acrylate, ethyl (meth)acrylate, butyl(meth)acrylate, t-butyl(meth)acrylate, isobutyl(meth)acrylate, hexyl(meth)acrylate, octyl(meth)acrylate, and 2-ethylhexyl(meth)acrylate; aryl (meth)acrylates such as phenyl(meth)acrylate; hydroxyalkyl(meth)acrylates such as hydroxyethyl(meth)acrylate and hydroxypropyl(meth)acrylate; glycidyl(meth)acrylate; N,N-dialkylaminoalkyl(meth)acrylate; (meth)acrylonitrile; (meth)acrylates having cycloaliphatic hydrocarbon groups such as tricyclodecane. The copolymerizable monomers include the styrene monomers, vinyl ester monomers, maleic anhydride, maleic acid, fumaric acid, and the like. These monomers may be used independently or in a combination of two or more kinds.

As the (meth)acrylic resins, there may be mentioned, for example, poly(meth)acrylic acid esters such as polymethyl methacrylate, a methyl methacrylate-(meth)acrylic acid copolymer, a methyl methacrylate-(meth)acrylic acid ester copolymer, a methyl methacrylate-acrylic acid ester-(meth)acrylic acid copolymer, and a (meth)acrylic acid ester-styrene copolymer (MS resin and the like). Preferable (meth)acrylic resins include poly(C1-6 alkyl(meth)acrylate)s such as polymethyl (meth)acrylate, especially, methyl methacrylate resins having methyl methacrylate as the main component (50 to 100% by weight, preferably about 70 to 100% by weight).

As preferable thermoplastic resins, usually used are resins which are amorphous and soluble in an organic solvent (especially a common solvent which can dissolve a plurality of polymers and curable compounds). Especially preferable are resins which have high moldability or a film forming property, transparency, and weatherability, for example, styrene resins, (meth)acrylic resins, cycloaliphatic olefin resins, polyester resins, and cellulose derivatives (cellulose esters and the like). Particularly, the cellulose derivatives are preferable as the thermoplastic resins. Since the cellulose derivatives are semi-synthetic polymers and have different dissolution behavior from other resins and curing agents, they possess excellent phase separation properties.

In addition, from a viewpoint of abrasion resistance after curing, there may be used as one polymer of the mutually incompatible polymers, for example, a polymer having a functional group which gets involved in a curing reaction (a functional group which can react with the curing agents). This kind of functional group includes a condensable or reactive functional group (for example, a hydroxyl group, an anhydride group, a carboxylic group, an amino group or an imino group, an epoxy group, an glycidyl group, and an isocyanate group), polymerizable functional group (for example, a C2-6 alkenyl group such as vinyl, propenyl, isopropenyl, butenyl, and allyl; a C2-6 alkynyl group such as ethynyl, propynyl, and butynyl; a C2-6 alkenylidene group such as vinylidene; or a functional group containing these polymerizable functional groups (a (meth)acryloyl group and the like).

The glass transition temperature of the polymer may be selected, for example, from a range of −50° C. to 230° C., preferably from a range of about 0° C. to 200° C. The weight average molecular weight of the polymer may be selected, for example, from a range of 1000000 or smaller, preferably from a range of about 1000 to 500000.

The combination of the first polymer and the second polymer is not particularly limited but it is preferable to combine two kinds of polymers which are mutually incompatible and easy to phase separate at around the processing temperature.

For example, when the first polymer is a cellulose derivative (for example, cellulose esters such as cellulose acetate propionate), the second polymer may be a styrene resin (polystyrene, a styrene-acrylonitrile copolymer, and the like), (meth)acryl resin, cycloaliphatic olefin resin (a polymer with norbornene as the monomer and the like), polycarbonate resin, and polyester resin (a poly(C2-4 alkylene arylate) copolyester and the like).

Further, the resin material may be a mixture of the above-described at least two resin materials, to which is added a curable compound and cured. The curable compound is a compound which comprises a functional group which reacts by heat rays, active energy rays (ultraviolet light, electron beam, etc.), and the like. Various curable compounds may be used, which can cure or crosslink by heat rays, active energy rays, and the like to form resins (especially cured or crosslinked resins).

The curable compounds can include, for example, heat-curable compounds or resins [low molecular weight compounds (or prepolymers, for example, low molecular weight resins such as epoxy resins, unsaturated polyester resins, urethane resins, and silicone resins) having epoxy groups, isocyanate groups, alkoxysilyl groups, silanol groups, and polymerizable groups (a vinyl group, allyl group, (meth)acryloyl group, and the like)]; and photocurable compounds (ultraviolet-curable compounds and the like such as photocurable monomers, oligomers, and prepolymers) which can be cured by active light rays (ultraviolet light and the like), wherein the photocurable compounds may be EB (electron beam) curable compounds and the like. In addition, the photocurable compounds such as the photocurable monomers, oligomers, and photocurable resins which may be of low molecular weight may sometimes be called simply as the “photocurable resins”. The curable compounds may be used independently or in a combination of two or more kinds.

The photocurable compounds usually contain photocurable groups, for example, polymerizable groups (a vinyl group, allyl group, (meth)acryloyl group, and the like) and photosensitive groups (a cinnamoyl group and the like). Especially, the photocurable compounds containing the polymerizable groups (for example, monomers and oligomers (or resins, especially low molecular weight resins)) are preferable.

Among the photocurable compounds having the polymerizable groups, the monomers can include, for example, monofunctional monomers [(meth)acrylic monomers such as (meth)acrylic acid esters, for example, alkyl(meth)acrylates (C1-6 alkyl(meth)acrylates such as methyl(meth)acrylate, cycloalkyl(meth)acrylates, (meth)acrylates having bridged cyclic hydrocarbon groups (isobornyl(meth)acrylate, adamantyl(meth)acrylate, and the like), glycidyl(meth)acrylate; vinyl monomers including vinyl esters such as vinyl acetate and vinyl pyrrolidone] and polyfunctional monomers having at least two polymerizable unsaturated bonds [alkylene glycol di(meth)acrylates such as ethylene glycol di(meth)acrylate, propylene glycol di(meth)acrylate, butanediol di(meth)acrylate, neopentyl glycol di(meth)acrylate, and hexanediol di(meth)acrylate; polyoxyalkylene glycol di(meth)acrylates such as diethylene glycol di(meth)acrylate, dipropylene glycol di(meth)acrylate, and polyoxytetramethylene glycol di(meth)acrylate; di(meth)acrylates having bridged cyclic hydrocarbon groups such as tricyclodecane dimethanol di(meth)acrylate, and adamantane di(meth)acrylate; polyfunctional monomers having about 3 to 6 polymerizable unsaturated bonds such as trimethylolpropane tri(meth)acrylate, trimethylolethane tri(meth)acrylate, pentaerythritol tri(meth)acrylate, pentaerythritol tetra(meth)acrylate, and dipentaerythritol penta(meth)acrylate.

The curable compounds, depending on their kinds, may be used in combination with curing agents. For example, the photocurable compounds may be used in combination with photopolymerization initiators.

As the photopolymerization initiators, there can be used, for example, acetophenones or propiophenones, benzils, benzoins, benzophenones, thioxanthones, and acylphosphine oxides. The content of the photoinitiators may be about 0.1 to 20 parts by weight based on 100 parts by weight of the curable compounds.

In addition, the phase separation property of a plurality of polymers can be evaluated easily by preparing a homogenous solution using a good solvent for each component and, in the step of gradually evaporating the solvent, observing visually whether the residual solid content becomes clouded or not.

The plurality of polymers form a co-continuous phase structure with progress of phase separation and, as the phase separation proceeds further, the continuous phase becomes discontinuous because of its own surface tension to assume a droplet phase structure (a sea-island structure with an independent phase of globular, spherical, discoidal, elliptical, and other shape).

Control of these phase separation phenomena can be done by adjusting the kinds, combination, and mass ratio of the polymers to be used. Any kinds of polymers may be used as long as they are mutually incompatible and, when forming an anti-glare layer, it is preferable to use a solution where the two or more kinds of incompatible polymers are dissolved in a common good solvent. Regarding the mass ratio of the polymers, it is better first to prepare a ternary phase diagram based on the two kinds of incompatible polymers and the common good solvent for the polymers and, then, control the drying step to pass the line (spinodal line) where spinodal degradation occurs. Such a spinodal line can be obtained according to a literature, for example, “Scaling Concepts in Polymer Physics”, p. 94-96, Cornell University Press.

### <Solvent>

The phase separation according to the present embodiment can be carried out by evaporating the solvent contained in the coating solution. Namely, the solvent not only dissolves the mutually incompatible polymers but also has a function to control the drying speed.

The solvent to be used can be selected depending on the kinds and solubility of the polymers, curable compounds, and the like. In the case of a mixed solvent, it suffices if at least one kind is a solvent which can dissolve the solid contents (a plurality of polymers and curable compounds, reaction initiators, and other additives) uniformly. Such solvents can include, for example, ketones (such as acetone, methyl ethyl ketone, methyl isobutyl ketone, and cyclohexanone), ethers (such as dioxane and tetrahydrofuran), aliphatic hydrocarbons (such as hexane), cycloaliphatic hydrocarbons (cyclohexane), aromatic hydrocarbons (such as toluene and xylene), halogenated hydrocarbons (such as dichloromethane and dichloroethane), esters (such as methyl acetate, ethyl acetate, and butyl acetate), water, alcohols (such as ethanol, isopropanol, butanol, and cyclohexanol), cellosolves (such as methyl cellosolve and ethyl cellosolve), cellosolve acetates, sulfoxides (such as dimethyl sulfoxide), amides (such as dimethylformamide and dimethylacetamide). These solvents may be used independently or in a combination of two or more kinds.

Further, when coating the coating solution on the support, the solvent may be selected depending on the kind of support so as not to cause dissolution, erosion, or swelling of the support. For example, when a triacetylcellulose film is used as the support, preferably used as solvents for the coating solution are, for example, tetrahydrofuran, methyl ethyl ketone, isopropanol, and toluene.

Viscosity of the coating solution can be adjusted to about 1 to 50 cP and the concentration of the coating solution is preferably at least 10% by mass lower than the critical solid content concentration at which phase separation occurs in the coating layer. With the concentration of the coating solution in the range, the time from completion of coating to occurrence of phase separation can be taken longer and, thus, the particles can be made to migrate to the air-liquid interface and the low refractive index layer is made easier to be formed. In addition, the aforementioned concentration is the concentration of the resin materials which phase-separate in the anti-glare layer and is a value which does not include the curable compounds and photopolymerization initiators.

### (Coating Step)

Next, as is shown in FIG. 1A, a coating solution containing resins 54A and 54B, and particles 56 is coated on a support 16 to form a coating layer 52. In the coating step, using a production apparatus (anti-glare film production apparatus) 10 shown in FIG. 2, the support 16 (including one on which there is already formed a functional layer of some sort) is delivered from a film roll 12 by a delivery apparatus 14. The running speed of the support 16 can be set at 0.1 to 1.5 m/sec.

The support 16 is guided by a guide roller 18 and is fed to a dust removal device 20. The dust removal device 20 is designed so that it can remove dust attached to the surface of the support 16. At downstream of the dust removal device 20, there is installed a coating unit, an extrusion-type coating device 22. The coating solution is designed to be coated successively or concurrently on the support 16 which is wound on the backup roller.

As the coating methods, there may also be used a dip-coating method, air-knife coating method, curtain coating method, slide coating method, roller coating method, wire-bar coating method, gravure coating method, micro gravure coating method, and the like.

### <Support>

The anti-glare film comprises an anti-glare layer formed on a support. The support to be used has light transmission of preferably 80% or higher, more preferably 86% or higher. The haze of the transparent support is preferably 2.0% or less, more preferably 1.0% or less. The refractive index of the support is preferably 1.4 to 1.7. Also, as the support, it is preferable to use a plastic film. Examples of the plastic film material include cellulose ester, polyamide, polycarbonate, polyester (for example, polyethylene terephthalate and polyethylene naphthalate), polystyrene, polyolefin, polysulfone, polyethersulfone, polyarylate, polyether imide, polymethyl methacrylate, and polyether ketone.

### (Particle Migration Step)

In the coating layer 52 applied on the support 16, while the support is conveyed to a drying zone 24, the particles 56 migrate to the air-liquid interface as is shown in FIG. 1B and the particles 56 become eccentrically located at the air-liquid interface in the coating layer 52. In the present invention, it is important to make the particles migrate to the air-liquid interface in this particle migration step. In the first embodiment, the migration of the particles is facilitated by providing the particles with hydrophobicity. Therefore, the drying speed of the coating layer to reach the critical solid content concentration at which phase separation occurs is preferably set at no less than 0.03 g/m²·s and no more than 5.0 g/m²·s. With the drying speed in the range, sufficient time can be taken for the particle migration step.

Further, in the particle migration step, it is preferable that 80% or more of the entire particles 56 are contained in the air-liquid interface of the coating layer 52, namely, the low refractive index layer 60 after drying. Especially preferably, the amount of the particles contained in the low refractive index layer is preferably 90% or more, even more preferably 95% or more. If the amount of the particles 56 contained in the low refractive index layer 60 is not in the range, it becomes difficult to obtain a distinct difference in the refractive index between the anti-glare layer 58 and the low refractive index layer 60, and, thus, the function to prevent reflection becomes insufficient.

### (Drying Step)

The support 16, provided with the coating layer 52 wherein the particles 56 have migrated to the air-liquid interface in the particle migration step, is conveyed to the drying zone 24. In the drying zone 24, the solvent evaporates and the resins 54A and 54B phase-separate to form a concavo-convex shape as is shown in FIG. 1C. The drying zone 24 is not particularly limited but a hot air heating apparatus (for example, the heat treatment apparatus described in Japanese Patent Application Laid-Open No. 2001-314799), heater heating apparatus, and the like can be used. When heating with hot air, the wind speed of hot air is preferably set at 1 m/sec or lower in order to suppress uneven drying.

At downstream of the drying step, there is disposed a curing step of the coating layer, where the coating layer is cured or crosslinked by heat rays or active energy rays (ultraviolet light, electron beam, and the like). The curing method may be selected depending on the kind of the curable compound and, for example, an ultraviolet irradiation apparatus 26 is used. By this ultraviolet irradiation, the desired curing and crosslinking can be obtained.

Also, depending on the material of the coating layer, there is a case where a heat treatment zone is installed for heat curing to carry out the desired curing and crosslinking. Alternatively, after the support 16 provided with the coating layer is taken up on a roll, the support may, in a separate step, be heated in an oven or conveyed for a heat treatment. Then, the support 16 having the anti-glare layer and the low refractive index layer formed thereon are taken up by a take-up device 30, installed downstream.

It is preferable that the phase separation (the concentration of resin materials in the coating solution exceeds the critical solid content concentration) starts after the particles are eccentrically located at the air-liquid interface (surface) of the coating layer. Thus, the particles which are mixed with the resin materials inside the film and taken into the film are reduced. An allowable amount of the particles taken into the film is determined depending on a target quality level regarding visibility including anti-glare property and reflectivity required by a finished product.

It is preferable that the phase separation starts after 40% or more particles have migrated to within 40% of a thickness of the coating layer from the side of the air-liquid interface. The phase separation starts, more preferably after 50% or more particles within 30% of the thickness from the side of the air-liquid interface, even more preferably after 60% or more particles within 20% of the thickness from the side of the air-liquid interface, even much more preferably after 70% or more particles within 10% of the thickness from the side of the air-liquid interface.

Further, when the phase separation starts after waiting for the eccentric location of the particles more than necessary, the amount of time until the completion of the drying of coating layer increases, resulting in decreasing the maximum production rate. Therefore, it is preferable that the phase separation starts as soon as possible to the extent that the quality of the finished product is allowable.

It is preferable that the staring of the phase separation is performed by any one of selection of the solvent, adjustment of the drying speed of the solvent and surface-modification of the particles, and can also be performed by any combination of them at a time.

For example, in order to start the phase separation after 70% or more particles present in the coating solution have migrated to within 10% of the thickness of the coating layer from the side of the air-liquid interface, it is preferable to use as the solvent a solvent which has a boiling point of 60° C. or higher, to adjust the drying speed of the solvent to 5.0 g/m²·s or lower, preferably 1.0 g/m²·s or lower, and to surface-modify the particles with a silane coupling agent having three or more fluorine atoms, for example, 3,3,3-trifluoropropylmethyldichlorosilane.

It is preferable that in the anti-glare film thus produced, 70% or more particles are present within 10% of a thickness of a functional layer, which is composed of a low refractive index layer and an anti-glare layer, of the anti-glare film from a surface of the functional layer. More preferably, 80% or more particles are present within 8% of the thickness of the functional layer, and even more preferably, 90% or more particles are present within 5% of the thickness of the functional layer.

### <Other Layers>

On the anti-glare film, produced by the method of producing an anti-glare film of the present invention, there may further be disposed a hard coat layer, forward scattering layer, primer layer, antistatic layer, undercoat layer, protective layer, and the like.

### (Hard Coat Layer)

The hard coat layer is disposed on the support in order to provide physical strength to the anti-glare film. The hard coat layer is preferably formed by a crosslinking reaction or polymerization reaction of photo- and/or thermally-curable compounds.

As the curable functional groups, preferable are photo-polymerizable functional groups and, as organometallic compounds containing hydrolyzable functional groups, preferable are organic alkoxysilyl compounds. Specific examples of these compounds include that the particle surface is treated with surface treating agents (for example, silane coupling agents: Japanese Patent Application Laid-Open Nos. H11-295503 and H11-153703, and Japanese Patent Application Laid-Open No. 2000-9908, anionic compounds or organometallic coupling agents: Japanese Patent Application Laid-Open No. 2001-310432), that a core-shell structure is employed with high refractive index particles as the core (Japanese Patent Application Laid-Open No. 2001-166104 and the like), and that a specific dispersant is used (for example, Japanese Patent Application Laid-Open No. H11-153703, U.S. Pat. No. 6,210,858B1, Japanese Patent Application Laid-Open No. 2002-2776069). Specific constituent compositions of a hard coat layer include those described in, for example, Japanese Patent Application Laid-Open Nos. 2002-144913 and 2000-9908, and International Publication WO 00/46617.

The film thickness of the hard coat layer is preferably 0.2 to 10 μm, more preferably 0.5 to 7 μm. Hardness of the hard coat layer as measured by the pencil hardness test according to JIS K5400 is preferably H or higher, more preferably 2H or higher, most preferably 3H or higher. Further, in the taper test according to JIS K5400, the smaller the abrasion amount of the test piece before and after the test, the more preferable it is.

### (Forward Scattering Layer)

The forward scattering layer, when applied to a liquid crystal display device, is disposed in order to provide an improvement effect in view angle when the viewing angle is inclined in up and down, and in right and left directions. By dispersing microparticles having different refractive indices in the hard coat layer, the hard coat function can also be obtained. For example, the following Patent Documents can be cited: Japanese Patent Application Laid-Open No. H11-38208 which specifies the forward scattering coefficient; Japanese Patent Application Laid-Open No. 2000-199809 which specifies the range of relative refractive indices of the transparent resin and the microparticles; Japanese Patent Application Laid-Open No. 2002-107523 which defines the haze value to be 40% or higher.

### EXAMPLES

Hereinafter, the features of the present invention will be described in more detail with reference to Examples. However, the scope of the present invention should not be limitatively interpreted by the Examples mentioned below.

### Example 1

On triacetyl cellulose of 80 μm thickness (Fujitac, produced by Fujifilm Corporation) employed as the support, the following coating solution was coated so that the thickness of the dry film became 6 μm. After coating, the coated film was dried at 60° C. for 1 minute under a dry air speed of 0.5 msec, followed by heat treatment at 100° C. for 1 minute. In this way, an anti-glare film provided with an anti-glare layer was produced.

### <Preparation of a Coating Solution>

The surface of hollow silica particles of an average particle diameter of 20 nm was hydrophobized with 3,3,3-trifluoropropylmethyldichlorosilane. A coating solution was prepared by dissolving 2 parts by mass of cellulose propionate, 15 parts by mass of an acrylic resin, and 0.2 part by mass of the hydrophobized hollow silica particles in 80 parts by mass of methyl ethyl ketone. The critical solid content concentration of this system was 29%.

The thus obtained anti-glare film was cut into predetermined sizes and the anti-glare property and glare were evaluated. Degrees of anti-glare property and blurring of the reflected image of a fluorescent lamp were visually observed and evaluated according to the following criteria:

A; the outline of a fluorescent lamp cannot be distinguished
B; the fluorescent lamp looks blurred but its outline can be distinguished (acceptable level as a product)
C; the fluorescent lamp hardly looks blurred.

As for the whitening phenomenon, the film obtained was pasted on a liquid crystal display and the visual quality was evaluated according to the following criteria:

A; whiteness is not felt
B; whiteness is slightly felt
C; whiteness is felt.

### Example 2

An anti-glare film was produced in the same manner as in Example 1, except that the average particle diameter of the particles used was 40 nm.

### Example 3

An anti-glare film was produced in the same manner as in Example 1, except that the treating agent for the hollow silica particles was heptadecafluoro-1,1,2,2-tetra-hydrodecyl) dimethylchlorosilane.

### Example 4

An anti-glare film was produced in the same manner as in Example 1, except that the coated film was dried under the drying condition of, at 25° C. for 1 minute at a dry air speed of 0.5 m/sec.

### Example 5

An anti-glare film was produced in the same manner as in Example 1, except that the coated film was dried under the drying condition of, at 25° C. for 1 minute at a dry air speed of 1.5 msec.

### Comparative Example 1

An anti-glare film was produced in the same manner as in Example 1, except that the hollow silica particles were not used.

### Comparative Example 2

An anti-glare film was produced in the same manner as in Example 1, except that the particles were not subjected to the hydrophobizing treatment.

### Comparative Example 3

An anti-glare film was produced in the same manner as in Example 1, except that the amount of methyl ethyl ketone was 64 parts by mass.

### Comparative Example 4

An anti-glare film was produced in the same manner as in Example 1, except that the average particle diameter of the particles was 80 nm.

### Comparative Example 5

An anti-glare film was produced in the same manner as in Example 1, except that the average particle diameter was 8 nm.

### Comparative Example 6

An anti-glare film was produced in the same manner as in Example 1, except that the coated film was dried under the drying condition of, at 80° C. for 1 minute at a dry air speed of 0.5 msec.

### Comparative Example 7

An anti-glare film was produced in the same manner as in Example 1, except that the coated film was dried under the drying condition of, at 60° C. for 1 minute at a dry air speed of 1.5 msec.

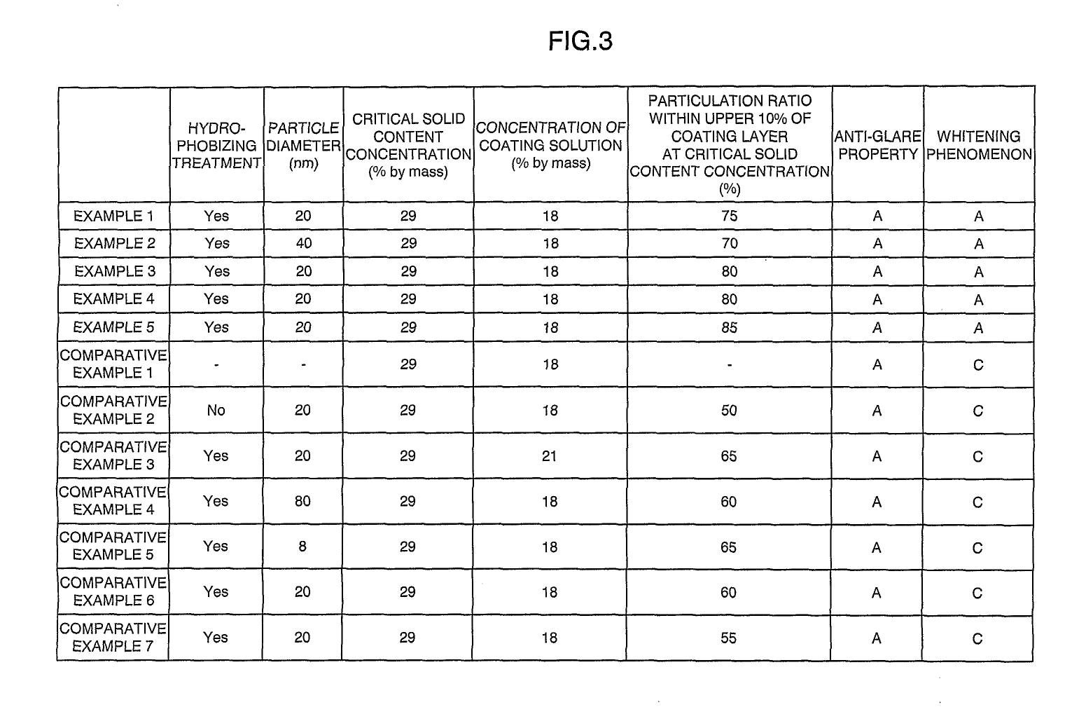

The results are shown in Table 1 of FIG. 3. By forming a low refractive index layer on the surface of the anti-glare film, the whitening phenomenon due to diffuse reflection could be prevented. Also, by a single coating, both the anti-glare layer and the low refractive index layer could be formed, thus providing a production method which is advantageous in terms of cost.

In Comparative Example 1 where no particles were used, the whitening phenomenon could not be prevented. Also, in Comparative Example 2 where no hydrophobizing treatment was provided, in Comparative Example 3 where the concentration of the coating solution was high, in Comparative Example 4 where the particle size was large, and in Comparative Example 5 where the particle size was small, the whitening phenomenon could not be prevented. This is thought to be because the particles could not migrate sufficiently to the air-liquid interface of the coating layer.

### REFERENCE SIGNS LIST

10 . . . anti-glare film production apparatus, 16 . . . support, 22 . . . coating device, 24 . . . drying zone, 26 . . . ultraviolet irradiation apparatus, 30 . . . take-up device, 52 . . . coating layer, 54A and 54B . . . resins, 56 . . . particles, 58 . . . anti-glare layer, 60 . . . low refractive index layer

1. A method for producing an anti-glare film, comprising:
a coating solution preparation step in which at least two mutually incompatible resin materials are dissolved in at least one solvent to prepare a coating solution containing particles;
a coating step in which the coating solution is coated on a support to form a coating layer;
a particle migration step in which the particles are made to migrate to an air-liquid interface of the coating layer to be eccentrically located on the surface of the coating layer; and
a drying step in which the coating layer is dried and phase-separated to form an anti-glare layer and to form, at the same time, a low refractive index layer comprising the particles on top of the anti-glare layer.

2. The method for producing an anti-glare film according to claim 1, wherein the concentration of the resin material in the coating solution is at least 10% by mass lower than a critical solid content concentration at which phase separation occurs in the coating layer.

3. The method for producing an anti-glare film according to claim 1, wherein the size of the particles is at least 10 nm and at most 50 nm.

4. The method for producing an anti-glare film according to claim 1, wherein the particles are surface-modified with a silane coupling agent.

5. The method for producing an anti-glare film according to claim 1, wherein 80% or more of the particles contained in the coating solution is included in the low refractive index layer.

6. The method for producing an anti-glare film according to claim 1, wherein the particles are hollow silica particles.

7. The method for producing an anti-glare film according to claim 1, in the drying step, at least one of selection of the solvent, adjustment of the drying speed of the solvent and surface-modification of the particles are carried out so that the concentration of the resin material in the coating solution which constitutes the coating layer exceeds the critical solid content concentration, after 40% or more of the particles contained in the coating solution have migrated to within upper 40% of the coating layer in the particle migration step.

8. The method for producing an anti-glare film according to claim 7, wherein, in the drying step, at least one of selection of the solvent, adjustment of the drying speed of the solvent and surface-modification of the particles are carried out so that the concentration of the resin material in the coating solution which constitutes the coating layer exceeds the critical solid content concentration, after 70% or more of the particles contained in the coating solution have migrated to within upper 10% of the coating layer in the particle migration step.

9. An anti-glare film produced by the method for producing an anti-glare film according to claim 1, wherein, 70% or more of the particles are present within 10% of a thickness of a functional layer of the anti-glare film from a surface of the functional layer.
